(19) United States
(12) Patent Application Publication
(10) Pub. No.: US 2017/0171439 A1
(43) Pub. Date: Jun. 15, 2017

(54) MOUNT FOR AN OBJECTIVE

(71) Applicant: Robert Bosch GmbH, Stuttgart (DE)

(72) Inventors: Nikolai Bauer, Moeglingen (DE); Ulrich Seger, Leonberg-Warmbronn (DE); Uwe Apel, Neckartailfingen (DE)

(21) Appl. No.: 15/349,548

(22) Filed: Nov. 11, 2016

(30) Foreign Application Priority Data
Dec. 15, 2015 (DE) 102015225232.9

(51) Int. Cl. H04N 5/225; G02B 7/02

(52) U.S. Cl. CPC H04N 5/2254; G02B 7/02

(57) ABSTRACT

A mount for an objective housing. The mount includes a hollow space that is circular-cylindrical about an axis and has at least three receptacle protrusions for holding the objective housing, between which the hollow space arises and that are designed to hold the objective housing through clearance-free contact. The receptacle protrusions include at least two ribs that each have at least two regions having different extensions in the radial direction, relative to the axis.

### CROSS REFERENCE

The present application claims the benefit under 35 U.S.C. §119 of German Patent Application No. DE 102015225232.9 filed on Dec. 15, 2015, which is expressly incorporated herein by reference in its entirety.

### FIELD

The present invention relates to a mount for an objective and to a corresponding objective.

### BACKGROUND INFORMATION

U.S. Pat. No. 5,493,452A describes a lens barrel having a cylindrical part for the radial positioning of a lens and for positioning the lens in the direction of the optical axis of the lens. The cylindrical part has a multiplicity of protrusions that are spaced uniformly and circumferentially around the interior of the cylindrical part, so that a circle circumscribed by the protrusions has the same diameter as the lens, the midpoint of the circle coinciding with the optical axis of the lens. Further lens mount systems are described in German Patent Application No. DE19623418A1, U.S. Pat. No. 5,808,817A, and U.S. Patent Appl. Pub. Nos. U.S. 2009/168204A, and U.S. 2011/292355A.

U.S. Patent Appl. Pub. No. 2006/00056077 A1 describes a mount in which a lens holder can be positioned very precisely relative to an image sensor using symmetrically situated flexible ribs. For the fastening of the lens holder, this holder is screwed onto the mount.

German Patent No. DE 35 33 401 A1 describes a clearance-free fit is disclosed for cylindrical mountings of photographic lenses. Here, a main mounting has radially symmetrical recesses that can be rotated relative to likewise radially symmetrical protrusions of an individual mounting in such a way that a nonpositive connection results between the main mounting and the individual mounting.

### SUMMARY

According to the present invention, a mount for an objective housing is provided. The mount includes a hollow space that is circular-cylindrical about an axis, and for holding the objective housing has at least three receptacle protrusions between which the hollow space arises, and that are designed to hold the objective housing through clearance-free contact. In accordance with the present invention, the receptacle protrusions have at least two ribs that each have at least two regions having different extension in the radial direction, relative to the axis.

The mount according to the present invention offers the advantage that the objective housing is held on the ribs at predefined support surfaces in the form of point contacts and/or line contacts and/or surface contacts. In contrast to a pressing on of the objective housing at an arbitrary or undefined point of the mount, in this way a highly precise situation of the objective housing in the mount is possible. Such a mount can be produced through highly precise casting or using an injection molding method. In addition, using the mount according to the present invention a long-lasting imager module can be realized with low assembly outlay that precisely defines the optical axes of an objective relative to the mount.

The at least two regions differ in their extension in the direction of the axis, going out from the inner side of the objective housing to which they are attached. The regions thus have different distances to the axis. Perpendicular (orthogonal) lines at the axis, going from the axis to a respective region, are thus different in length. Thus, the extension in the radial direction, relative to the axis, is understood as an extension of the regions from the inner side toward the axis in the direction orthogonal to the axis.

In an advantageous specific embodiment of the present invention, the receptacle protrusions additionally include a clamping receptacle protrusion, so that the clearance-free contact can be realized by at least three support surfaces. The at least three support surfaces can be formed by the clamping receptacle protrusion and the at least two ribs.

This specific embodiment offers the advantage that a highly precise fit between the objective housing and the mount is possible by using an objective housing having an eccentric protrusion. Through a rotation of the objective housing relative to the mountain, the eccentric protrusion can be pressed against the clamping receptacle protrusion, whereby a nonpositive connection can be produced between the objective housing and the mount. Here, the objective housing is pressed by the eccentric protrusion and the clamping receptacle protrusion onto the support surfaces defined precisely by the ribs. In this way, an assembly of mount and objective bearer can be carried out that is adapted optimally to an optics installed in the objective bearer.

In a further specific embodiment of the mount, the mount has exactly two ribs and one clamping receptacle protrusion. The ribs and the clamping receptacle protrusion here extend parallel to the axis and are configured so as each to be offset by 120° to one another.

This specific embodiment offers the advantage that through the two ribs a wedge support results, or a wedge fit of an objective bearer in the mount is possible. In this case, an objective housing can be placed onto the ribs at two or four point contacts and/or line contacts and/or surface contacts. Through a rotation of the objective housing, which has an eccentric protrusion, in this way there results a highly precise nonpositive connection. The configuration does not have to take place exactly in steps of 120°. Deviations of up to 10° do not present a problem or a limitation of the functioning of the specific embodiment.

In a further specific embodiment of the mount, the two ribs are fashioned such that through the objective housing, at least two support surfaces separated spatially from one another can be formed, each having one rib.

This specific embodiment offers the advantage that through the spatially separated support surfaces two support surfaces can be formed per rib. These support surfaces are parallel to the axis at positions spatially separate from one another, whereby a kind of lever effect can arise when an objective housing is put in place, which can be exploited for the precise positioning and contributes to the stability of the connection between the objective housing and the mount.

In a further specific embodiment of the present invention, the receptacle protrusions are designed such that the clearance-free contact between the mount and the objective housing can be realized through five support surfaces spatially separate from one another. The support surfaces can be formed by the two ribs and the clamping receptacle protrusion.

This specific embodiment offers the advantage that given two ribs, four highly precise support surfaces can be created that position the objective with a high degree of precision relative to the mount. In this case, through the fifth receptacle surface the clamping receptacle protrusion produces the nonpositive fit, and consequently the nonpositive connection.

In addition, an objective housing is provided for the mount in accordance with the present invention. The objective housing has an eccentric protrusion and, apart from the eccentric protrusion, has at least two cylindrical outer surfaces having different diameters. The outer surfaces and the eccentric protrusion are fashioned such that the objective housing can be held by the mount by introducing it into the hollow space in a first angular position and, through rotation into a second angular position with the aid of the eccentric protrusion, clamping it between a receptacle protrusion and at least two ribs.

The objective housing according to the present invention offers the advantage that with this objective housing a highly precise assembly is possible between the objective housing and the mount. If the objective housing additionally has an optics and if an image sensor is to be attached on the mount, then using this objective housing a highly precise camera module design can be produced. In addition, such a housing is easy to produce because the highly precise support surfaces are provided in the mount. An eccentric protrusion is understood as any positive contour that is attached on one of the outer surfaces of the objective housing and as a result of which the corresponding outer surface is no longer precisely circular.

In a further specific embodiment of the objective housing, during the placement of the objective housing into the mount, through the two cylindrical outer surfaces at least two support surfaces can be formed per rib.

The various angular positions correspond to two different relative rotations between the objective housing and the mount.

In a further specific embodiment of the present invention, during the placement of the objective housing into the mount and through rotation of the objective housing into the second angular position, at least five support surfaces can be formed by the two cylindrical outer surfaces and the eccentric protrusion.

In addition, an imager module is provided in which at least one mount and one objective housing are combined.

In a further specific embodiment of the imager module, the objective housing is held by the mount through clearance-free contact by five support surfaces. The five support surfaces are formed through the contact between the eccentric protrusion and clamping receptacle protrusion and the contact between two cylindrical outer surfaces and two ribs.

This specific embodiment offers the advantage that a particularly stable and highly precise situation of the objective housing in the mount can be achieved.

### BRIEF DESCRIPTION OF THE DRAWINGS

Exemplary embodiments of the present invention are explained in more detail on the basis of the figures and the description below.

FIG. 1 shows an imager module design according to the related art.

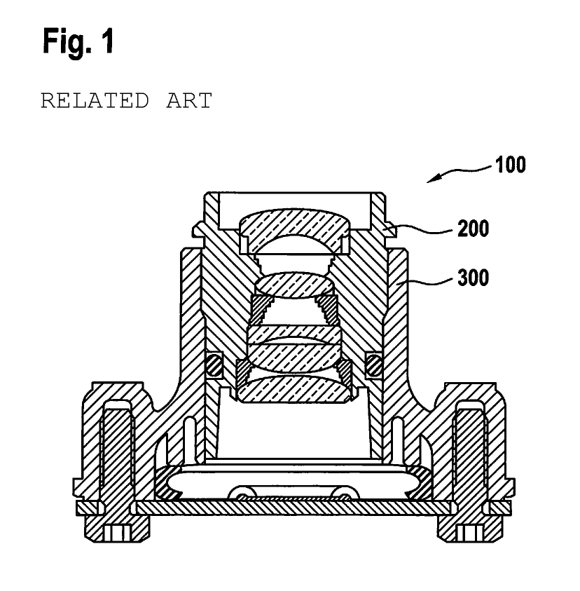

FIG. 2 shows an imager module design according to an exemplary embodiment.

FIGS. 3A and 3B show an exemplary specific embodiment of the mount.

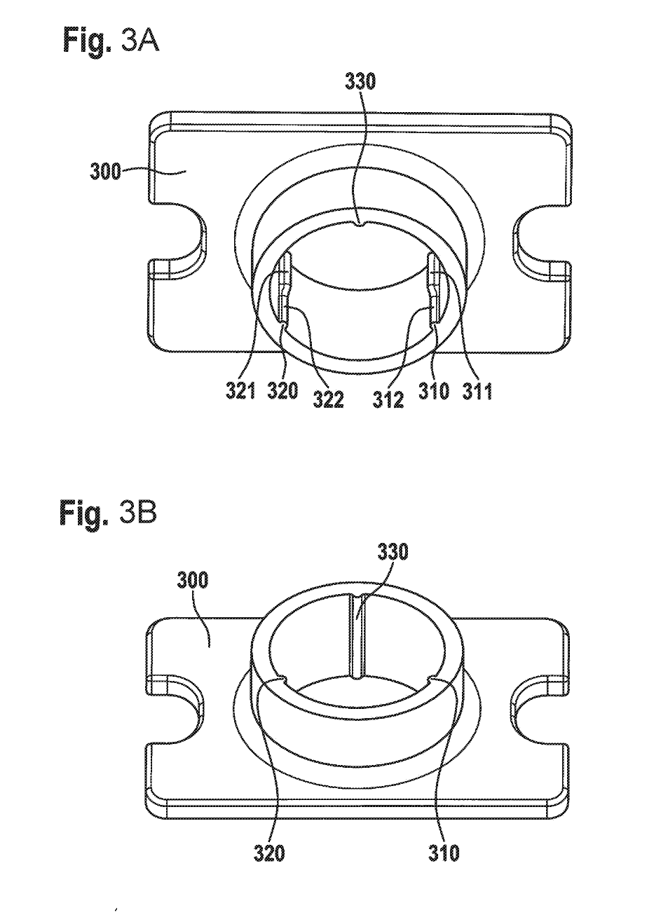

FIG. 4 shows sectional images of an exemplary imager module.

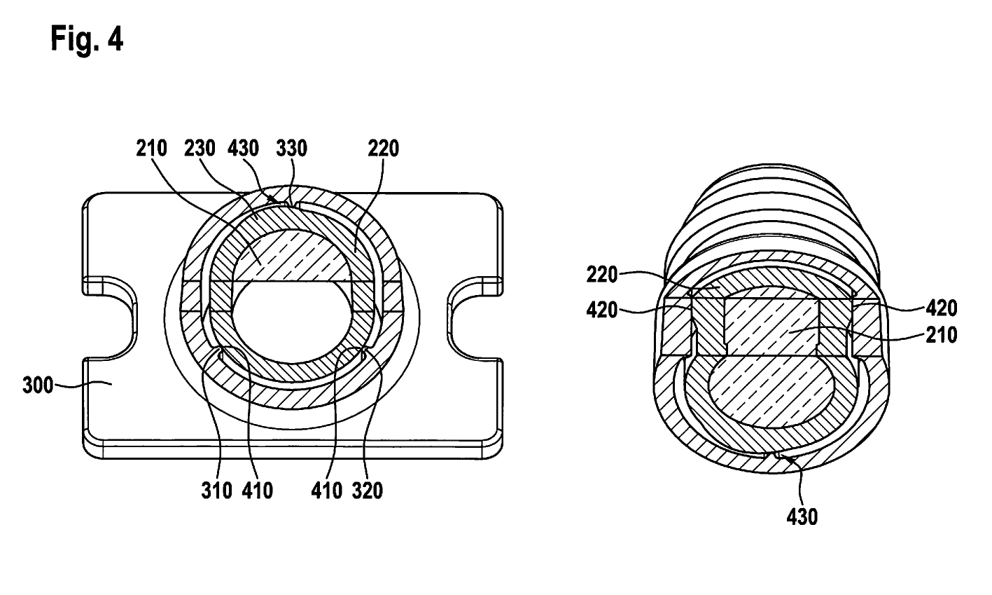

FIG. 5 shows a sectional image through an exemplary imager module.

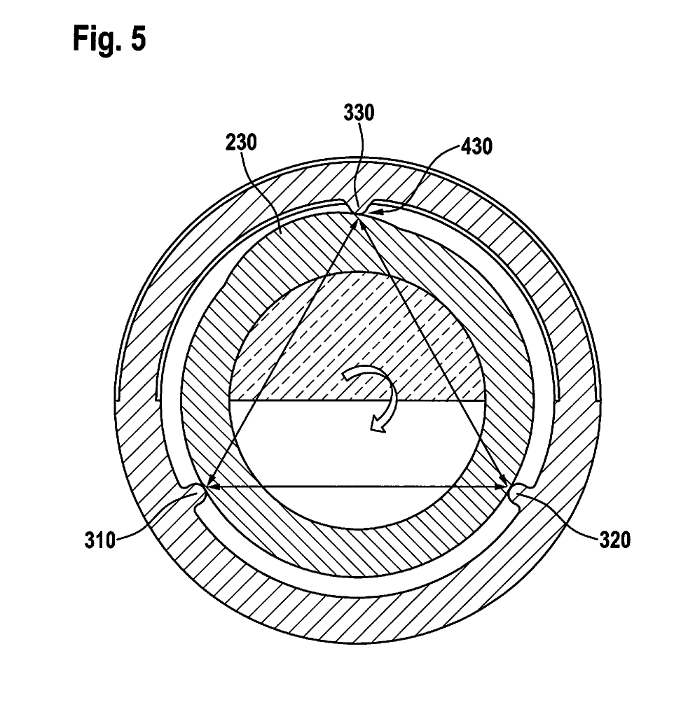

FIGS. 6A and 6B show the support surfaces/press-on regions between an exemplary objective bearer and an exemplary mount, and the design of a wedge fit/V-support.

### DETAILED DESCRIPTION OF EXAMPLE EMBODIMENTS

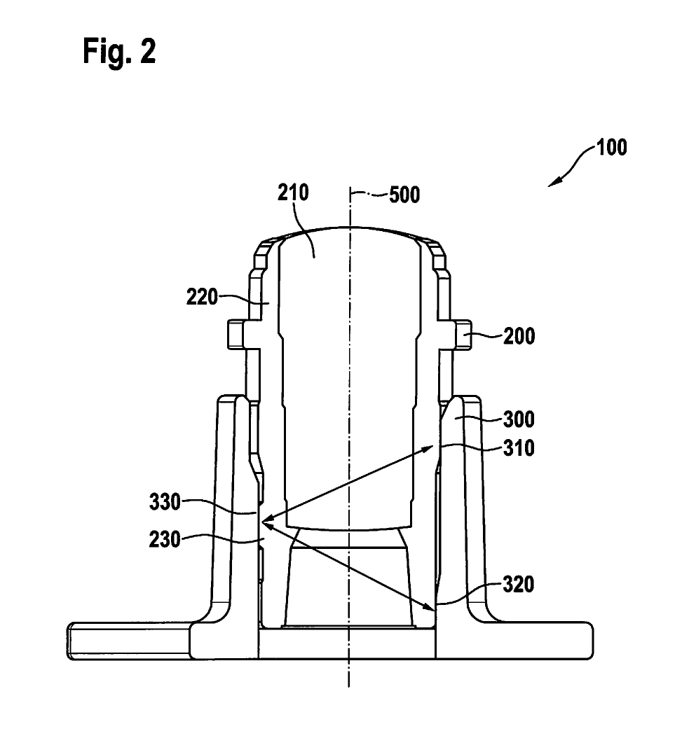

FIG. 2 shows an imager module design according to a first exemplary embodiment, in a sectional view. Imager module 100 includes an objective 200 in an objective housing 220, and a mount 300. Objective housing 220 and mount 300 are based on a circular cylindrical design. Mount 300 is a tube having a circular cross-section. In the tube there is an open hollow space that is circular-cylindrical relative to an axis 500.

The mount has three receptacle protrusions 310, 320, 330, shown in FIG. 2. Receptacle protrusions 310, 320, 330 are fashioned as two ribs 310, 320 and as clamping receptacle protrusion 330. The ribs each have two regions 311, 312, 321, 322 that have different extensions in the direction of axis 500. In this exemplary embodiment, ribs 310, 320 are fashioned parallel to axis 500, and each have two different step heights 311, 312, 321, 322. Between the steps, the extension of ribs 310, 320 increases in linear fashion in the direction of axis 500. Ribs 310, 320 and clamping receptacle protrusion 330 are situated in the interior of mount 300 so as to each be offset by 120° relative to one another. Clamping receptacle protrusion 330 has no step contour or different extensions. All parts of mount 300 are made of plastic in this specific embodiment, but alternatively can also be made of metal or other materials.

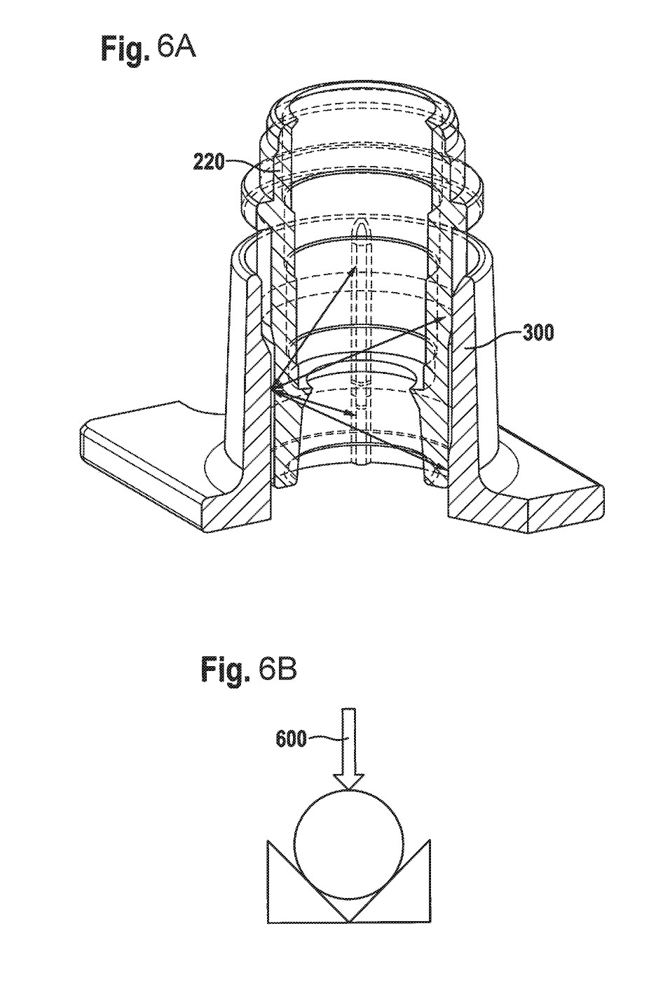

In FIGS. 6A and 6B, objective housing 220 is clearly shown. Objective housing 220 has an eccentric protrusion 230. Apart from eccentric protrusion 230, objective housing 220 has at least two cylindrical outer surfaces having different diameters. The outer surfaces and eccentric protrusion 230 are fashioned such that objective housing 220 can be held by mount 300 in that it is introduced into the hollow space in a first angular position and, through rotation into a second angular position with the aid of eccentric protrusion 230, is clamped between a receptacle protrusion 330 and at least two ribs 310, 320.

The two ribs 310, 320 form a kind of wedge or V support that is shown schematically in FIG. 6B. Through the rotation of objective housing 220 into the second angular position, objective housing 220 is pressed onto support surfaces 410, 420 of ribs 310, 320 by eccentric protrusion 230 and clamping receptacle protrusion 330. Schematically, this is shown by force arrow 600. In this way, there arises a nonpositive connection between objective housing 220 and mount 300. In this way, through a precise manufacturing of ribs 310, 320, a highly precise situation of objective housing 230 in mount 300 is possible, because ribs 310, 320 define the position of objective housing 230 radially to axis 500.

Due to the different extension of ribs 310, 320, two support surfaces 410, 420 result per rib 310, 320 and objective housing 220. Respectively, these are a lower support surface 410 and an upper support surface 420. In this case, lower support surfaces 410 are situated further from the opening into which objective housing 220 is placed, and upper support surfaces 420 are correspondingly closer to this opening. Ribs 310, 320 thus form, with objective housing 220, four support surfaces 410, 420. In this example, the support surfaces are realized by line supports. Alternatively, point contacts or surface contacts can also be used, which presupposes a corresponding construction of ribs 310, 320.

The press contact or clamping surface 430 between eccentric 230 and clamping receptacle protrusion 330 forms fifth support surface 430 in this exemplary embodiment. Through the five support surfaces 410, 420, 430, objective housing 230 can be positioned relative to axis 500 in the radial direction, and also the orientation of an optical axis of an objective 200 installed in objective housing 220 can be precisely adapted. In this way, a precise situation of an objective 200 in mount 300 can be ensured, which enables a highly precise camera module construction given an additional installation of an image sensor. FIGS. 6A and 6B again illustrates the clamping effect and the flow of force (represented by the arrows having two heads), which arise through the rotation of objective housing 220 relative to mount 300 and the pressing of eccentric protrusion 203 onto clamping receptacle protrusion 330.

Through the imager module according to the exemplary embodiments, for example a camera can be constructed, whether a photo camera or a video camera or a photo/video camera, that can be used in consumer devices, industrial applications, or in driver assistance systems.

What is claimed is:

1. A mount for an objective housing, the mount comprising:
a circular-cylindrical hollow space about an axis;
at least three receptacle protrusions for holding the objective housing, between which the hollow space arises and that are designed to hold the objective housing through clearance-free contact, wherein the receptacle protrusions include at least two ribs that each have at least two regions having different extension in a radial direction, relative to the axis.

2. The mount as recited in claim 1, wherein the receptacle protrusions additionally include a clamping receptacle protrusion, so that the clearance-free contact can be realized by at least three support surfaces, the at least three support surfaces being capable of being formed by the clamping receptacle protrusion and the at least two ribs.

3. The mount as recited in claim 2, having two ribs, the clamping receptacle protrusion and the ribs extending parallel to the axis and being configured so that they are each offset by 120° relative to one another.

4. The mount as recited in claim 3, wherein the two ribs are fashioned such that through the objective housing, at least two support surfaces spatially separated from one another can be formed each having one rib.

5. The mount as recited in claim 4, wherein the receptacle protrusions are designed such that the clearance-free contact between the mount and the objective housing are realized by five support surfaces spatially separated from one another, which are formed by the two ribs and the clamping receptacle protrusion.

6. An objective housing for a mount, the mount having a circular-cylindrical hollow space about an axis, and at least three receptacle protrusions for holding the objective housing, between which the hollow space arises and that are designed to hold the objective housing through clearance-free contact, wherein the receptacle protrusions include at least two ribs that each have at least two regions having different extension in a radial direction, relative to the axis, the objective housing having an eccentric protrusion, and, apart from the eccentric protrusion, having at least two cylindrical outer surfaces having different diameters, the outer surfaces and the eccentric protrusion being fashioned such that the objective housing can be held by the mount by introducing it into the hollow space in a first angular position, and, through rotation into a second angular position with the aid of the eccentric protrusion, clamping it between a receptacle protrusion and at least two ribs.

7. The objective housing as recited in claim 6, wherein when the objective housing is placed into the mount, at least two support surfaces can be formed per rib by the two cylindrical outer surfaces.

8. The objective housing as recited in claim 6, wherein when the objective housing is placed into the mount, and through rotation of the objective housing into the second angular position, at least five support surfaces can be formed by the two cylindrical outer surfaces and the eccentric protrusion.

9. An imager module having an objective housing held by a mount, the mount having a circular-cylindrical hollow space about an axis, and at least three receptacle protrusions for holding the objective housing, between which the hollow space arises and that are designed to hold the objective housing through clearance-free contact, wherein the receptacle protrusions include at least two ribs that each have at least two regions having different extension in a radial direction, relative to the axis, the objective housing having an eccentric protrusion, and, apart from the eccentric protrusion, having at least two cylindrical outer surfaces having different diameters, the outer surfaces and the eccentric protrusion being fashioned such that the objective housing can be held by the mount by introducing it into the hollow space in a first angular position, and, through rotation into a second angular position with the aid of the eccentric protrusion, clamping it between a receptacle protrusion and at least two ribs.

10. The imager module as recited in claim 9, wherein the objective housing is held by the mount through clearance-free contact by five support surfaces, the five support surfaces being formed by the contact between the eccentric protrusion and the clamping receptacle protrusion and the contact between two cylindrical outer surfaces and two ribs.
